(19) United States
(12) Patent Application Publication
(10) Pub. No.: US 2008/0016115 A1
(43) Pub. Date: Jan. 17, 2008

(54) Managing Networks Using Dependency Analysis

(75) Inventors: Paramvir Bahl, Sammamish, WA (US); Ranveer Chandra, Kirkland, WA (US); David A. Maltz, Bellevue, WA (US); Suman Nath, Redmond, WA (US); Ming Zhang, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/555,571

(22) Filed: Nov. 1, 2006

Related U.S. Application Data
(60) Provisional application No. 60/807,574, filed on Jul. 17, 2006.

(51) Int. Cl. G06F 17/00

(52) U.S. Cl. 707/104.1

(57) ABSTRACT

In a network management system, dependency relationships of network clients and network elements are computed. In an implementation, a dependency graph is generated based on the relationships, and the probabilities of problems associated with the network client and network element are determined based on the dependency graph.

### RELATED APPLICATIONS

The present application claims priority under 35 U.S.C. § 119(e) to U.S. Provisional Application No. 60/807,574 filed Jul. 17, 2006, the disclosure of which is incorporated herein.

### BACKGROUND

Users in a distributed network often encounter service disruptions, such as unavailability or poor performance. In such distributed networks, apart from clients and servers, a number of other components, such as routers, switches, links, etc., and services (e.g., Domain Name Service (DNS), Authentication Service (Active Directory, Kerberos)), may be a cause of disruption. When such problems arise, users may have to rely on network administrators or helpdesk to resolve their problems. Existing automated systems to counter these problems may either only present various types of raw data or focus on network-layer problems while overlooking problems experienced by applications.

Existing systems may employ designer-generated rules that spell out an application's dependencies. This approach has several problems that include, for example, the system may evolve faster than the rules are updated, and variations in the application's dependencies due to deployment of various forms of middle boxes (i.e., firewalls, proxies). Similarly, analysis of configuration files to determine dependencies may be insufficient as many dependencies among network components are dynamically constructed. For example, web browsers in enterprise networks are often configured to communicate through a proxy, sometimes named in the browser preferences, but frequently contacted through automatic proxy discovery protocols that themselves rely on resolution of well-known names.

In other approaches, systems have been proposed to expose dependencies by having applications run on a middleware platform instrumented to track dependencies at run time. In general, networks may run a plethora of platforms, operating systems, and applications, often from different vendors. While a single vendor might instrument their software, it is unlikely that all vendors will do so in a common fashion. Therefore, building all distributed applications over a single middleware platform may be infeasible. Furthermore, many underlying services on which other services depend (e.g., Domain Name Service), may be legacy services and cannot easily be instrumented or ported to run over a middleware platform instrumented to track dependencies at run time.

### SUMMARY

This summary is provided to introduce simplified concepts of managing networks using dependency analysis, which is further described below in the Detailed Description. This summary is not intended to identify essential features of the claimed subject matter, nor is it intended for use in determining the scope of the claimed subject matter

In an embodiment, dependency analysis is performed on a managed network by receiving dependency relationships of network elements related to network clients, generating a dependency graph based on these dependency relationships. The dependency graph is then used to aid management of the network, which may include: (1) establishing probabilities of occurrence of problems correlated to network elements and network clients; (2) determining which network elements are dependent on which other network elements.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

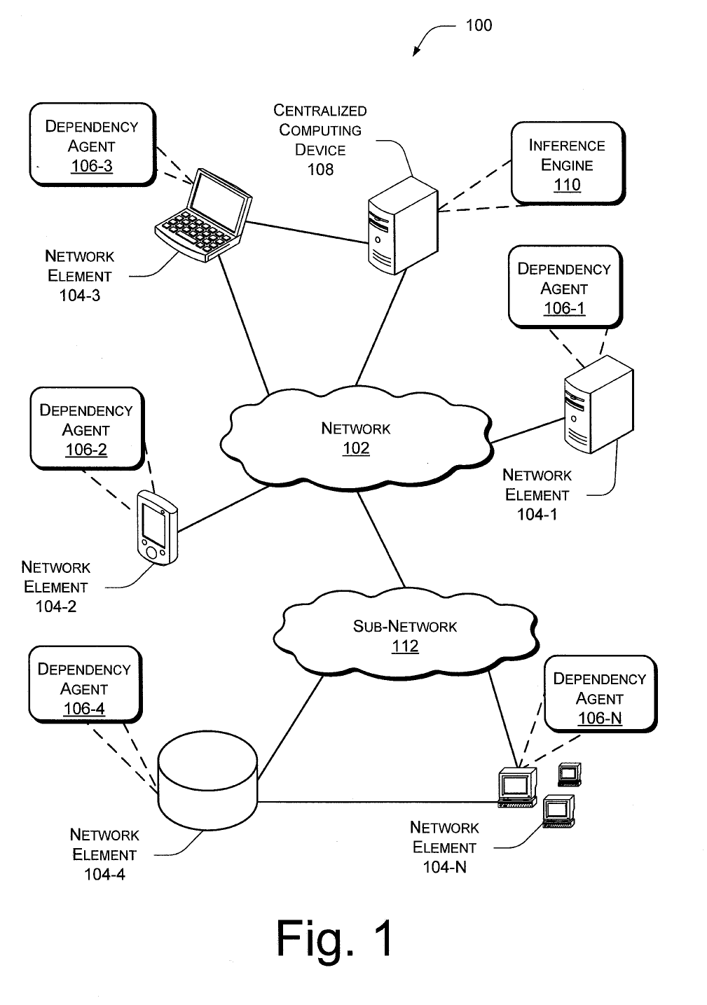

FIG. 1 is an illustration of an exemplary management system.

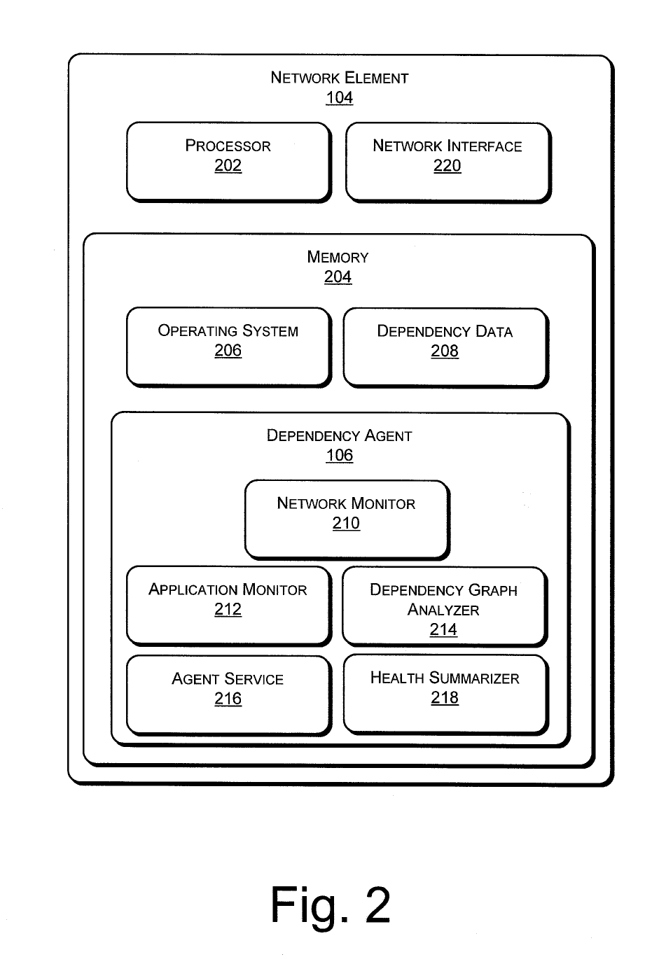

FIG. 2 is an implementation of a network element employing an exemplary dependency agent.

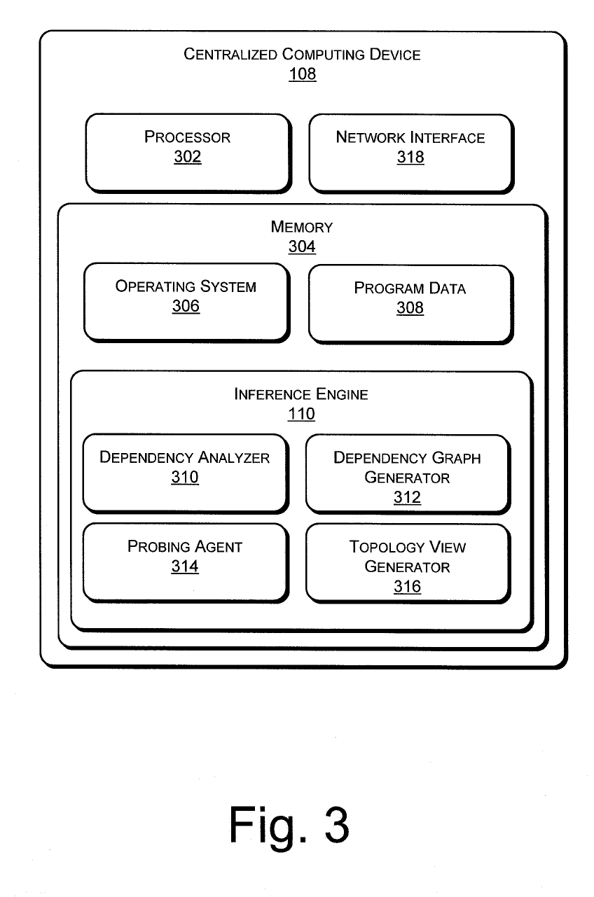

FIG. 3 is an implementation of a centralized computing device employing an exemplary inference engine.

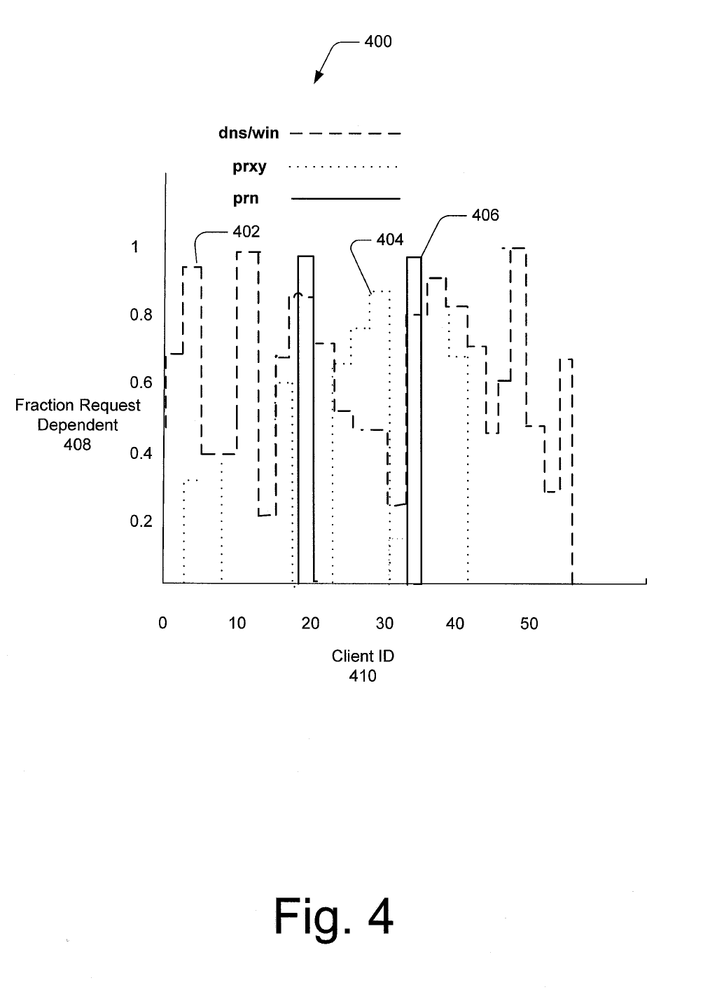

FIG. 4 is a graphical representation of the finding of dependencies of network clients communicating with an internal web server.

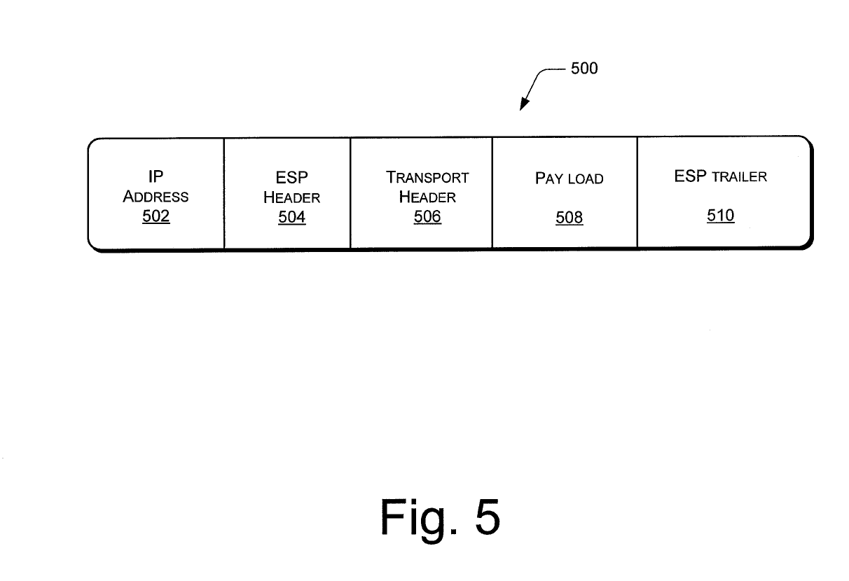

FIG. 5 is an illustration of an exemplary data packet.

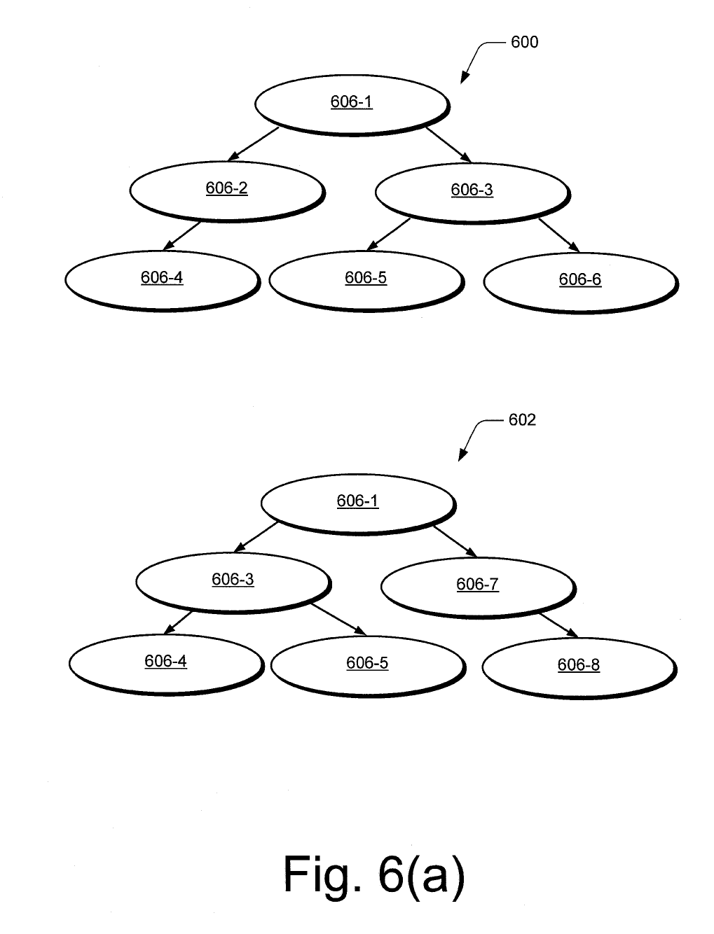

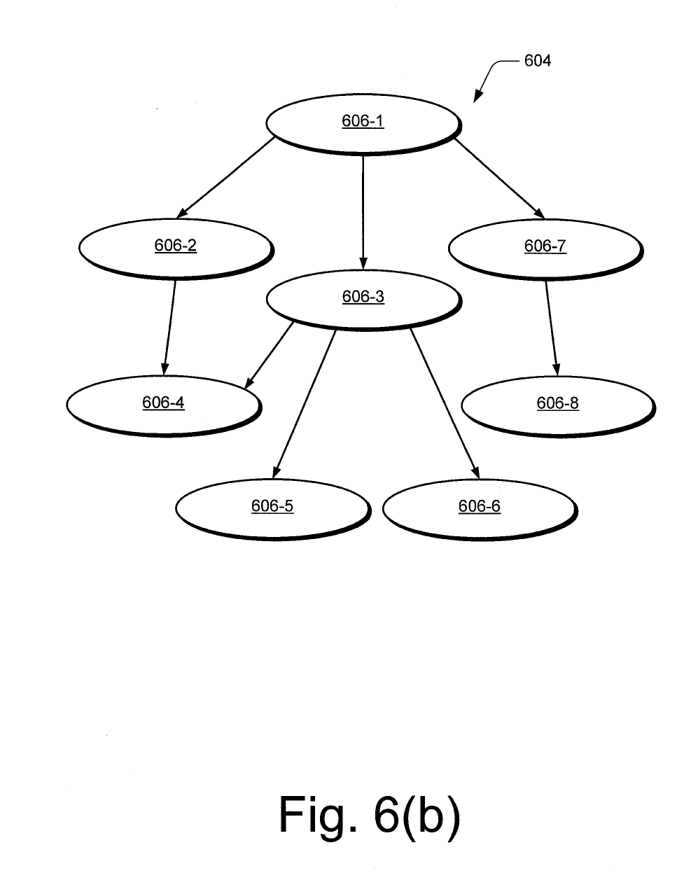

FIG. 6(a) is an illustration of an exemplary network topology views from network elements.

FIG. 6(b) is an illustration of an exemplary network topology view from centralized computing device.

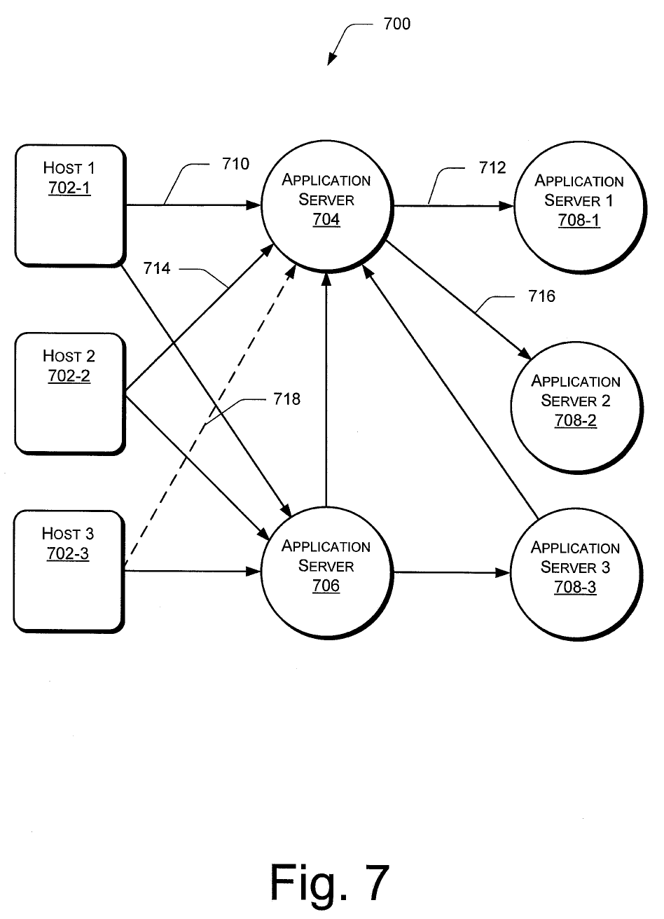

FIG. 7 is an illustration of an exemplary dependency graph of network clients communicating with an application server.

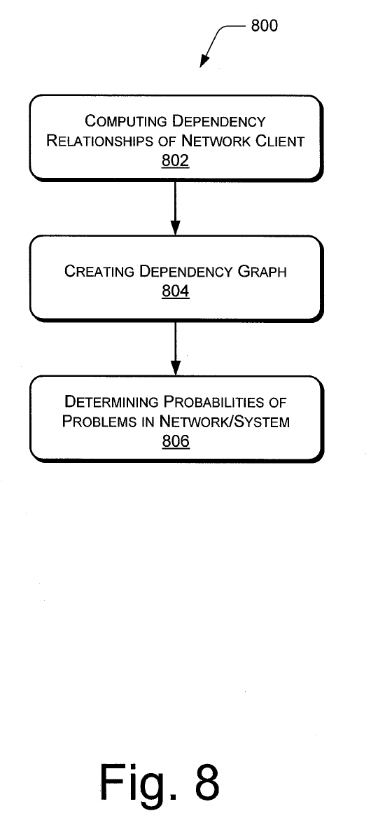

FIG. 8 is an illustration of an exemplary method of managing networks using dependency analysis according to one implementation.

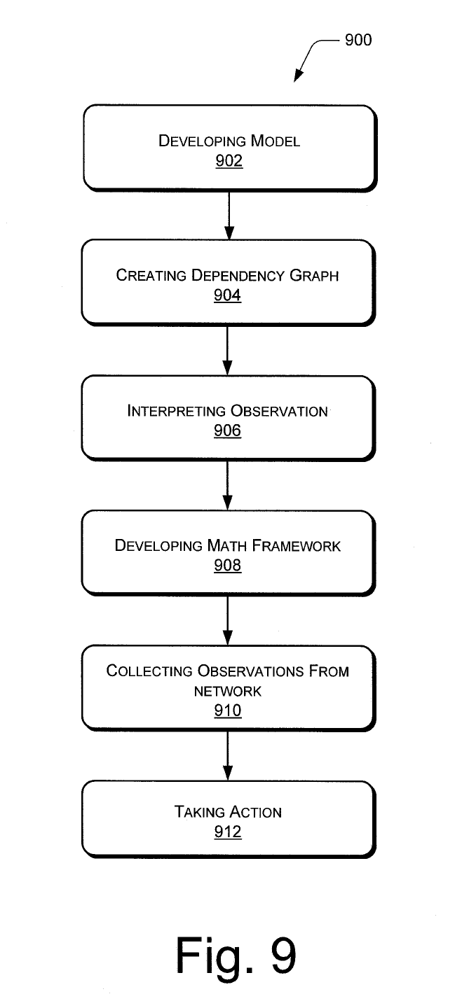

FIG. 9 is an illustration of an exemplary method of managing networks using dependency analysis according to another implementation.

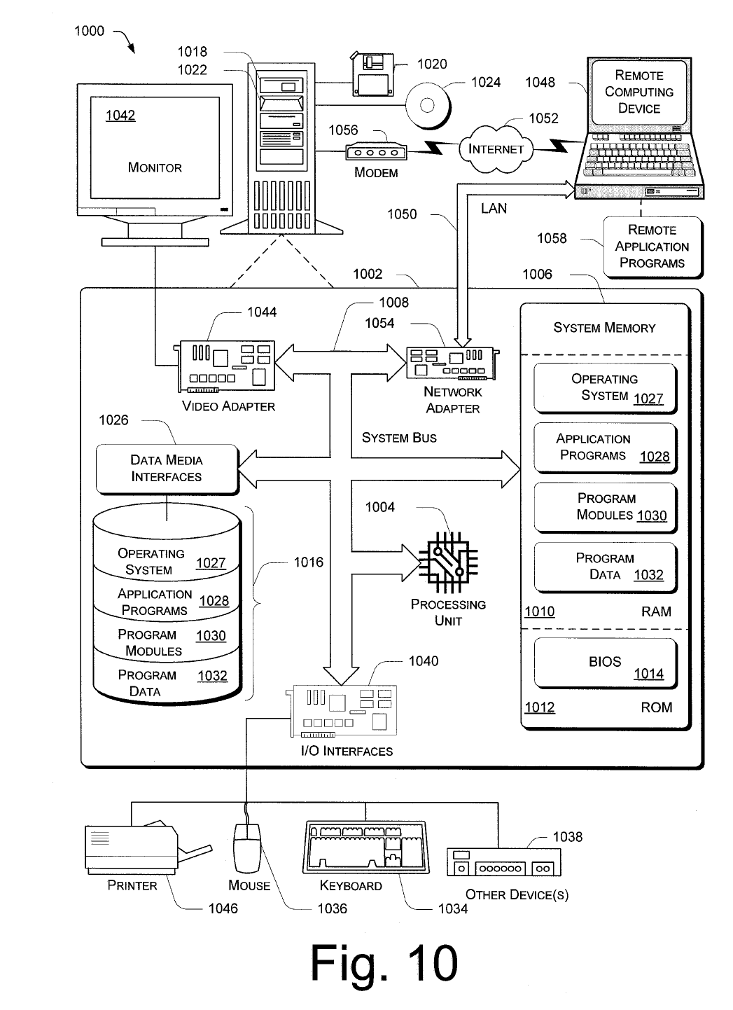

FIG. 10 is an illustration of a general computing environment implementing centralized computing device/network element.

### DETAILED DESCRIPTION

The following disclosure describes systems and methods for managing networks using dependency analysis. While aspects of described systems and methods for managing network using dependency analysis can be implemented in any number of different computing systems, environments, and/or configurations, embodiments are described in the context of the following exemplary system architectures.

### Exemplary Management System

FIG. 1 shows an exemplary management system 100 for a distributed network. The system 100 includes a network 102 through which one or more network elements 104-1, 104-2, 104-3, 104-4, . . . , 104-N communicate. Network elements 104 may include any electrical or processing component of the network such as servers, routers, switches, hubs, middle-boxes, firewalls, proxies, etc., where dependencies may be found among network elements 104 (i.e., servers, clients, services, routers, switches, links, middle-boxes, etc). The network 102 may include routers, switches, links, middle-boxes, etc. Servers and clients may be part of or connected to by the network 102. The network 102 may include, for example, one or more of the following: local area network, wide-area network, wireless network, optical network, etc. In this implementation, the network 102 also provides a communication medium to a centralized computing device 108 and a sub-network 112. The sub-network 112 may further connect to the one or more network elements 104.

In an exemplary implementation, one or more of the network elements 104-1, 104-2, 104-3, 104-4, . . . , 104-N respectively employ dependency agents 106-1, 106-2, 106-3, 106-4, . . . , 106-N, to automatically identify interactions and uncover dependency relationships between the network elements 104 and various resources in the network 102. In alternate embodiments, the network elements 104 may include one or more of PDAs, desktops, workstations, servers, routers, switches, hubs, services, etc. Dependency agents may also be connected to passive, non-electrical, or non-processing components of the network (e.g., optical fibers, Ethernet cables, links) via taps or sniffers.

An enterprise network is defined as hardware, software and media connecting information technology resources of an organization. A typical enterprise network is formed by connecting network clients, servers, a number of other components like routers, switches, etc., through a communication media. The network element 104 may be considered as a “network client”, where the network client is a part of the enterprise network that is characterized as an interface with an end user. The user may run an application or a program on the network client. The network client, for supporting the application being run on it, may have to depend upon other components in the enterprise network, such as, servers, routers, switches, services, links, etc. For the purposes of illustration with regard to an enterprise network, a network element 104 is referred to, in this description as a “network client” for the context described above. The other components of the enterprise network, on which the network client may depend, have been referred to as “other network elements”.

The network element 104, in an exemplary implementation, employs a distributive approach to approximate the dependency relationships using low-level packet correlations. This approach is explained in detail under the section titled “Exemplary Dependency Agent”. The network element 104 discovers dependency relationships of other network elements 104. These dependency relationships are represented as dependency graphs.

In one of the implementations, the discovered dependency relationships are received at the centralized computing device 108. The centralized computing device 108 employs an inference engine 110 to generate dependency graphs. In alternate embodiments, the centralized computing device 108 may include a cluster of servers, workstations, and the like. The centralized computing device 108 may be configured to assemble dependency relationships and generate a dependency graph for the network 102 spanning across all the network elements 104 and sub-network 112. In this implementation, the generated dependency graphs are utilized to determine the probability of occurrence of problems, and localize faults in the network 102. The dependency graphs thus generated are utilized for the management of distributed networks, for example, an enterprise network.

In yet another implementation, the dependency graphs include relationships representing network topology. The manner, in which the centralized computing device 108 generates the dependency graph and network topology is explained in the section titled “Exemplary Inference Engine”.

### Exemplary Dependency Agent

FIG. 2 shows a network element 104 according to an embodiment. Accordingly, the network element 104 includes one or more processors 202 coupled to a memory 204. Such processors could be for example, microprocessors, microcomputers, microcontrollers, digital signal processors, central processing units, state machines, logic circuitries, and/or any devices that manipulate data based on operational instructions. The processors are configured to fetch and execute computer-program instructions stored in the memory 204. Such memory 204 includes, for example, one or more combination(s) of volatile memory (e.g., RAM) and non-volatile memory (e.g., ROM, Flash etc.). The memory 204 stores computer executable instructions and data for determining dependency relationship of the network element 104 with other network elements.

In an exemplary implementation, the memory 204 stores operating system 206 providing a platform for executing applications on the network element 104. The memory further stores a dependency agent 106 capable of identifying interactions and discovering dependency relationships of the network element 104. To this end, the dependency agent 106 includes a network monitor 210, an application monitor 212, a dependency graph analyzer 214, an agent service 216 and a health summarizer 218. The dependency relationships thus generated is stored in dependency data 208 for drawing future inferences. A network interface 220 provides the capability of network element 104 to interface with the network 102 or other network elements 104. The dependency agent 106 takes a passive approach to generate a dependency graph for any network element while the inference engine may proactively or periodically instruct a dependency agent to generate a dependency graph.

In an exemplary implementation, the dependency agent 106 determines the dependency relationships of the network element 104 as follows. Local traffic correlations are inferred by passively monitoring packets and applying statistical learning techniques. The basic premise is that a typical pattern of messages is associated with accomplishing a given task. Therefore, the dependency relationships may be approximated by taking the transitive closure of strongly correlated network elements. Moreover, a fault can be detected by observing the absence of expected messages.

In this embodiment, the network monitor 210 builds an “activity model” for its own traffic in which it correlates input and output of the network element 104. This activity model is based on an “activity pattern” of input and output of the network element 104. The output and input represent channels between which data packets flow and thus between which an edge exists in the dependency graph. For example, all packets sharing the same source and destination address might be designated as belonging to a single channel. Additionally, an application protocol is utilized to identify a channel. Channels are described as input or output channels based on whether they represent messages received at or transmitted by the network element 104. A value of either active or inactive is assigned to each channel in the network over some fixed time window. A set of such assignments to channels at a network element 104 is an “activity pattern” for that network element, indicating whether or not a packet was observed on each channel during the observation time window. The activity pattern for the network element 104 is stored in dependency data 208.

In this embodiment, the activity model represents a matrix of correlation coefficients between the input and the output of the network element 104. Such correlation coefficients in the activity model encode the confidence level for a dependency between two network elements.

The “activity model” for a network element is a function, mapping the “activity pattern” of the input channels to a vector of probabilities for each output channel being active. Since activity patterns discard all packet timings and counts within the observation time window, picking a suitable duration for the window is critical. Over a very long time window all the channels can be found to be related, whereas selecting a window size that is too small will cause correlations to be missed. The network monitor 210, in one embodiment, can be configured to develop models for a given range of window size and combine the resulting models. The network monitor 210, according to this embodiment, may apply statistical learning techniques to passively monitor packets for the purpose of modeling. In particular, the learning technique is based on the likelihood of the outputs (i.e., the transmitted packets), given the observed inputs (i.e., the received packets), over some fixed time window.

The network monitor 210 extracts standard packet header information, such as timestamp, protocol, source and destination IP address, and identifies the packet's application or service, for example, by using well-known IP port numbers. In alternate embodiments, the network monitor 210 collects network data by, for example, sniffing the packets, tracing the route of packets, etc. An exemplary data packet monitored by the network monitor 219 is described under section titled “Exemplary Data Packet”. In an embodiment, the network monitor 210 is implemented by invoking functionality in the operating system 206 to make available to the dependency agent 106 and network monitor 210 a copy of part or all of each packet sent or received by the network element 104. Exemplary mechanisms providing such functionality are PCAP and NetMon. Alternate embodiments may obtain information about the packets in other ways or other forms, such as at layer 4 (e.g., socket-layer information from LSP).

In another implementation, the dependency graph analyzer 214 may be configured to set an appropriate threshold for deciding that a correlation is strong enough to be part of the dependency graph. The dependency graphs that are generated may be utilized for the management of distributed networks, for example, an enterprise network.

In an implementation, the health summarizer 218 reports the condition and health probability of network elements 104 in the network. The health summarizer 218 in the dependency agent 106 computes the probability of occurrence of a problem in the network elements 104. In an implementation, the health summarizer assigns a probability of sickness to the network elements. One embodiment of a health summarizer compares the response time of a request sent to another network element with a historical record of response times and assigns a probability of health or sickness to that network element based on the deviation of the response time above the historical median. Alternate embodiments of a health summarizer include: (1) processing system log files to identify error codes indicating potential sickness on the network element; (2) processing responses from network elements to identify response codes, strings, or patterns that indicate potential sickness on the network element.

The application monitor 212 enables the dependency agent 106 to determine the dependency relationships for an application or a service being provided to the network elements 104 by a particular network element. In an alternate embodiment, the application monitor 212 detects an application failure and generates a symptom report, which is stored with the dependency data 208.

In an alternative embodiment, this invention may be implemented by a network-based system that does not require deployment of dependency agents to clients or servers or changes to clients or servers. It could deploy, for example, packet extraction means like packet sniffers etc. at various locations in the enterprise network, and infer the dependency relationship of each network client 104 from these traces. In this embodiment, the traces of packets collected from each sniffer are processed to identify all packets sent or received by each network element. These virtual packet traces are then processed using the mechanisms taught in this application as if they had been collected by a dependency agent running on each of the clients. It may be appreciated that for purposes of exemplary illustration, collection, processing, and distribution of packet traces may be performed by methods known in the art.

### Exemplary Inference Engine

FIG. 3 shows a centralized computing device 108 according to an embodiment. Accordingly, the centralized computing device 108 includes one or more processors 302 coupled to a memory 304. Such processors could be, for example, microprocessors, microcomputers, microcontrollers, digital signal processors, central processing units, state machines, logic circuitries, and/or any devices that manipulate data based on operational instructions. The processors are configured to fetch and execute computer-program instructions stored in the memory 304. Such memory 304 includes, for example, one or more combination(s) of volatile memory (e.g., RAM) and non-volatile memory (e.g., ROM, Flash etc.). The memory 304 stores computer executable instructions and data for determining dependency graphs based on the multiple dependency relationships received from multiple network elements 104.

In an exemplary implementation, the memory 304 stores operating system 306 providing a platform for executing applications on the network element. The memory further stores an inference engine 110 capable of aggregating and coordinating the dependency data 208 from one or more of the network elements 104 in the system 100. To this end, the inference engine 110 includes a dependency analyzer 310, dependency graph generator 312, probing agent 314 and a topology view generator 316. Any data that is required for the execution of inference engine 110 and dependency data received from network elements 104 is stored in the program data 308 for future uses. A network interface 318 provides the capability of centralized computing device 108 to interface with the network 102 or other network elements 104. In alternate embodiments, the inference engine 110 may be a part of one or more network elements 104. In yet another embodiment, the inference engine 110 may be distributed over multiple network elements 104. The inference engine 110 maintains a proactive approach to generate a dependency graph for the whole network or a part thereof.

In an exemplary implementation, the inference engine 110 incorporates “Analysis of Network Dependencies” or “AND” approach to determine the dependency relationships of the network elements 104 in the network 102. In this approach, the centralized inference engine 110 and the set of dependency agents 106 coordinate to assemble dependency data from one or more network elements 104. Each dependency agent 106 performs temporal correlation of the packets sent and received by the corresponding network elements 104 and makes summarized information, in the form of dependency data, available to the inference engine 110. The inference engine 110 therefore serves as an aggregation and coordination point for the dependency data received, assembling the dependency graph for applications by combining information from the dependency agents 106, ordering the dependency agents to conduct active probing as needed to flesh out the dependency graph or to localize faults and interfacing with the human network managers.

In this embodiment, the dependency analyzer 310 may invoke the probing agent 314 to send a request for the dependency data to one or more of the network elements 104. Upon receipt of such a request, the dependency agent 106 sends the local dependency data of the corresponding network element 104. The dependency data received from the dependency agents 106 is stored in the program data 308. In an alternate embodiment, instead of sending the whole dependency data, the dependency agents 106 may send only the change in the dependency data if any. The dependency analyzer 310 retrieves the dependency data from the program data 308 to assemble the dependency graph for the applications or services. In another embodiment, the dependency analyzer 310 computes the dependencies of the network elements using a report of deltas. The deltas refer to the change in the dependency data from the last received dependency data.

In an embodiment, the dependency graph generator 312 generates a combined dependency graph based on the assembled dependency data from the dependency graph analyzer 310.

The centralized computing device 108 is capable of being interfaced to an administrator or a human network manager to provide a statistical performance report of the network 102 and the network elements 104.

### Fault Localization Using Dependency Graphs

In an exemplary implementation, each dependency agent 106 observes experiences of its network element 104, for example, by measuring response time between requests and replies etc. When a user on the network element, flags the experience as bad, for example, by restarting the browser or hitting a button that means “I'm unhappy now”; or when automated parsing discovers too many “invalid page” HTTP return codes, the dependency agent 106 sends a triggered experience report to the inference engine 110. A small number of randomly selected positive experiences, for example, the time to load a web page when the user did not complain, may be sent to the inference engine periodically. The dependency graph analyzer 310 keeps updating the dependency data and experience reports and in a given time window, batches experience reports from multiple agents. It applies Bayesian inference to find the most plausible explanation for the experience reports, for example, the minimum set of faulty physical components that would afflict all the network elements 104, routers and links with poor performance while leaving unaffected the network elements 104 experiencing acceptable performance.

In another embodiment, for accomplishing efficient fault localization, when the application monitor in the network client 104 detects application failures, it sends failure symptom reports to the inference engine 110. The symptom reports include the network elements such as routers, links and other applications which are affected by the detected failures. Since a single failure (e.g., a server down or link congestion) often affects many network clients or hosts (i.e., network element 104), the inference engine 110 will receive multiple symptom reports in a short period of time. The dependency analyzer 310 aggregates a burst of reports and uses a Bayesian inference algorithm to find the most plausible explanation to all these symptom reports (e.g., the minimum set of faulty physical components that can affect all the hosts, routers and links in the symptom reports).

In yet another implementation, the dependency graph is utilized to localize link congestion faults. To this end, layer-2 topology is mapped by using the dependency agents 106 to send and listen for MAC broadcast packets and the layer-3 topology is mapped by using trace routes. This may also be accomplished by, for example, extracting dependency data from SNMP data. The accuracy with which congestion faults are localized may increase as more and more accurate topology information is available.

The inference engine 110, therefore, builds the dependency graphs by continuously accumulating the dependency data that it receives from the dependency agents 106. Since important applications are typically hosted on servers with high fan-in, the inference engine 110 identifies these servers and automatically builds a dependency graph for each one. The same node may appear in multiple local dependency graphs generated by the network element itself, for example, a DNS server may be shared by multiple applications and network clients. In an implementation, the dependency graph generator 312 leverages this overlap by collapsing the shared nodes into one, aggregating the local graphs into a complete dependency graph of an enterprise network.

FIG. 4 illustrates a graphical representation 400, for finding of dependency relationships between network client 104 and other network elements, for example, an internal server. The graph 400 shows an implementation of the AND approach depicting the fraction of requests made by clients to a server, that were also dependent on other network elements or services (DNS, Proxy, Print Server) over a time window. The graph 400 illustrates fraction of requests dependent 408 and client ID 410 on the axes. The fraction of requests dependent 408 represents the fraction of request made by that client to the server that co-occurred with a request to the given service. A fraction requests dependent 408 equal to “1” refers to a case where every client request to the server co-occurred with a request to the given service. In the embodiment, illustrated in FIG. 4, the requests were made by each client to a DNS, a proxy and a Print Server that co-occur with a request to a common web server (i.e., the server). Accordingly, it can be gathered from the graph 400, that most clients invoke DNS when making web requests, although not 100% of the time due to caching. This is represented by 402. However, in an alternate embodiment, the correct dependency can still be extracted by expanding the time window and combining the resulting dependency relationships. The graph 400 also shows that some network clients 104 are dependent on the proxy that is normally used for external access, even when accessing the internal web server while a couple of network clients 104 are dependent on print server. This is represented by 404 and 406 respectively. In another embodiment, the dependency graph analyzer 310 can be configured to detect different classes of policy/configuration faults.

### Exemplary Data Packet Structure

An exemplary data packet structure 500 as is monitored by the network monitor 210, is illustrated in FIG. 5. Accordingly, the network monitor 210 in the network element 104 parses various segments of the data packet 500 to extract packet information required for activity modeling. In an embodiment, these segments include internet protocol (IP) header 502, Encapsulating Security Payload (ESP) header 504, transport header 506, payload 508 and ESP trailer 510. The internet protocol header 502 provides the source and destination IP addresses of the data packet. The ESP provides confidentiality for IP datagrams or packets, which are the message units that the internet protocol deals with, by encrypting the payload data to be protected. The transport header 506 is used by the transport layer protocol. The payload 508 refers to the data being transmitted. In this embodiment, the network monitor 210 includes packet sniffing components known in the art to inspect data packets transmitted and received at the network element and identify potential packet casualties.

### Generation of Network Topology View

In an implementation, the inference engine 110 can utilize the dependency data received from network elements 104 to generate a network topology. FIG. 6(a) shows network topology view from two network elements 104. In this embodiment, the probing agent 314 sends a probe request to the dependency agent 106, requesting a topology view at the network element 104, of which the dependency agent 106 is a part. On receipt of such a request, the dependency agent 106 generates a network topology view 600 at the network element based on the dependency data 208. Similarly, another network topology view 602 is generated at a second network element. Each of the topology views 600 and 602 include network elements 606-1 to 606-8 represented as nodes and an edge between them representing a connection between the nodes. As shown in the FIG. 6(a), a node may appear in more than one network topology view, for example, 606-1, 606-4 etc. Furthermore, a given node may be connected to different set of nodes in different network topology views, for, example, 606-3 is not connected to 606-4 in the topology view 600 unlike in the topology view 602. The dependency agent 106 sends the network topology views 600 and 602 to the inference engine 110. The topology view generator 316, on receipt of these topology views, performs a mapping to determine a combined network topology view as illustrated by 604 in FIG. 6(b). The inference engine 110 may be configured to request and collect topology views from multiple network elements and a complete network topology can be generated.

### Generation of Dependency Graph

A dependency graph represents the dependencies between the network elements, with sub-graphs representing the dependencies pertaining to a particular application or activity. In an implementation, the dependency graph includes nodes and directed edges connecting the nodes. The nodes, in such an implementation, represent a network element 104 and the directed edge may represent interdependence between the connected nodes. In an alternate embodiment, the dependency graph may depict the interdependence of the network element 104 for an activity or a service.

The dependency graph that is generated may be stored in the dependency data 208. When the dependency graph is large, the “most likely path” can be searched for by the agent service 216. The dependency graphs may be generated on-demand and give a snapshot of recent history at each network element 104.

The inference engine 110, therefore, builds the dependency graphs by continuously accumulating the dependency-data that it receives from the dependency agents 106. Since important applications are typically hosted on servers with high fan-in, the inference engine 110 identifies these servers and automatically builds a dependency graph for each one. The same node may appear in multiple local dependency graphs generated by the network element itself, for example, a DNS server may be shared by multiple applications and network clients. In an implementation, the dependency graph generator 312 leverages this overlap by collapsing the shared nodes into one, aggregating the local graphs into a complete dependency graph of an enterprise network.

Each dependency agent 106 continuously updates a correlation matrix of the frequency with which two channels are active within a time window, for example, 100 ms. In an embodiment, the inference engine 110 polls the dependency agents 106 for their correlation matrices. FIG. 7 illustrates how aggregating such correlation matrices from multiple dependency agents 106 over a long period of time can find dependencies that might be obscured by caching, since even infrequent messages to a server become measurable when summed over many network elements 104. For purposes of exemplary description of the dependency graph illustrated in FIG. 7, the network elements 104 executing applications are referred to as a “host machines” or “hosts”. For example, as shown in the FIG. 7 applications are being run on servers 704, 706, 708-1, 708-2, and 708-3. The host machines are 702-1, 702-2 and 702-3. Both servers and clients are represented as nodes and their dependencies are depicted by edges joining the corresponding nodes. In practice, many hosts will have a correlation matrix similar to host 3 that shows a strong dependence on the application server 706, but no dependence on application service 704 as the application server's address has been cached. However, the matrices for host machines 702-1 and 702-2 show that when these hosts communicated with the application server they also communicated with application service in the same time window, for example, 100 ms. If enough hosts that communicate on channel A (e.g., the application server 706) also communicate on channel B (e.g., application server 704) within the same 100 ms, then the inference engine 110 infers that any host depending on channel A most likely depends on channel B as well and will add to the dependency graph as a dependency on B, as shown by the dashed edge 718 in the FIG. 7. The edge 718 indicates dependency found by aggregating information across hosts.

In another embodiment, each edge in the dependency graph also has a weight, which is the probability with which it actually occurs in a transaction. For example, in FIG. 7 host 702-1 contacts the application server 704, 710 fraction of the time before it accesses the application service 704. Similarly, the weight attached to the edge connecting the host 702-1 and the application server 706 is represented by 718 and so on. Furthermore, 712 and 716 also represent the fraction of time after which the application service 704 accesses the application servers 708-1 and 708-2 respectively Networks that include either fail-over or load-balancing clusters of servers, for example, primary/secondary DNS servers, application services, web server clusters, application server clusters etc. are modeled by introducing a meta node into the dependency graph to represent each such cluster, for example, the application service node in FIG. 7. It may be appreciated that for identifying clusters and detection of cluster configurations, heuristics and methods known in the art may be employed.

In one of the implementations, in addition to the hosts 702 and application server 706 and application services 704, the AND approach extends the dependency graph by populating it with other network elements 104 which may include, for example, routers, switches and physical links, PDA's, servers, services etc.

Referring back to FIG. 2, in another embodiment, the agent service 216 receives requests for collecting dependency data and commands to probe the network (e.g., network 102). For example, when a network element 104 wishes to determine its dependency relationship for a particular service, the agent service 216 queries the relevant peers/other network elements to find strong next-hop correlations in their activity models for when only the input channel on which the query was sent is active. This query is then forwarded to those peers who repeat the process, and thus results in transitive correlations. These transitive correlations are combined by the dependency graph analyzer 214 to generate a dependency graph from the point of view of the network element 104.

### Exemplary Methods

Exemplary methods for managing networks using dependency analysis are described with reference to FIGS. 1 to 7. These exemplary methods may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 8 illustrates an exemplary method 800 for managing a network using dependency analysis. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 802, dependency relationships of network elements are computed by the dependency agent 106 configured to identify interactions of the network client 104 with other network elements. This may be done, in an embodiment, by invoking the network client 104 to send a probe request. Upon receipt of such a request, the dependency agent 106 of the corresponding network client 104 gathers dependency relationships and creates a correlation matrix depicting correlation between the input and output of the network client. The matrix is stored in dependency data 208. In another implementation, receipt of the dependency relationship is based on applications provided to the network client 104. In yet another embodiment, the dependency relationships are received based on applications provided to the network elements.

At block 804, dependency graphs are created based on the received dependency relationships, stored in dependency data 208. In an implementation, the dependency graphs may be generated by the dependency agent 106. In another embodiment, multiple dependency graphs are received at a centralized computing device 108. The inference engine 110 in the centralized computing device 108, acts a coordination and aggregation point for all such dependency data from multiple dependency agents 106. Upon receipt of dependency data from network clients 104 in the network, the inference engine 110 assembles and generates a comprehensive dependency graph for the whole network. In one of the embodiments, a network topology view of the network is created by the inference engine 110 by aggregating multiple network topology views as generated by the dependency agents 106 at the corresponding network elements.

At block 806, probabilities of problems associated with the network elements and network clients 104 are determined. This determination is based on the dependency graph generated at block 804. In an embodiment, this may be accomplished by the dependency agent 106, which assigns a probability of sickness to the network elements on which the network client 104 depends. In yet another embodiment, the probabilities assigned by the dependency agent 106 is received as dependency data by the inference engine 110 which keeps updating the probability upon receipt of one or more of such dependency data from the corresponding network client 104. In an alternate embodiment, the creation of dependency graphs and determination of probabilities is included as part of managing the network in which the multiple dependency graphs and network topology views are generated. In one of the embodiments, Bayesian inference is incorporated in a diagnosis algorithm for determining problems associated with the network client 104 and the network elements.

FIG. 9 illustrates a method 900 for managing networks using dependency analysis according to another implementation. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

Accordingly at block 902, a model for representing the network elements 104 and their dependencies is developed. In this model, the network elements 104 are represented by nodes and the dependencies between any two nodes are represented by an edge connecting the two nodes.

At block 904, a dependency graph is generated based on the model developed at block 902. In an embodiment, the creation of the dependency graph may take into account the application provided to a network element by another.

At block 906, the observations from the dependency relationship as depicted by the dependency graph created at block 904 is interpreted. In an implementation, this may be done by a network administrator. This further includes turning raw observations into events signifying heath or sickness. In one of the embodiments, each edge in the dependency graph is assigned a weight which may be probability of sickness or health.

At block 908, a mathematical framework is developed to account for changes in the probabilities assigned to the edges at block 906. This may further include updating the probabilities when an event occurs.

At block 910, the observations from multiple network elements 104 are assembled and a comprehensive observation for the whole network is obtained. This observation may be updated based on a time window set by the administrator. The overall observation can be statistically processed to produce experience reports and performance analysis reports. In yet another embodiment, the processed report may be presented to an administrator.

At block 912, an action if required can be taken appropriate to the report presented at block 910.

### Exemplary Computer Environment

FIG. 10 illustrates an exemplary general computer environment 1000, which can be used to implement the techniques described herein, and which may be representative, in whole or in part, of elements described herein. The computer environment 1000 is only one example of a computing environment and is not intended to suggest any limitation as to the scope of use or functionality of the computer and network architectures. Neither should the computer environment 1000 be interpreted as having any dependency or requirement relating to any one or combination of components illustrated in the example computer environment 1000.

Computer environment 1000 includes a general-purpose computing-based device in the form of a computer 1002. Computer 1002 can be, for example, a desktop computer, a handheld computer, a notebook or laptop computer, a server computer, a game console, and so on. The components of computer 1002 can include, but are not limited to, one or more processors or processing units 1004, a system memory 1006, and a system bus 1008 that couples various system components including the processor 1004 to the system memory 1006.

The system bus 1008 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 1002 typically includes a variety of computer readable media. Such media can be any available media that is accessible by computer 1002 and includes both volatile and non-volatile media, removable and non-removable media.

The system memory 1006 includes computer readable media in the form of volatile memory, such as random access memory (M) 1010, and/or non-volatile memory, such as read only memory (ROM) 1012. A basic input/output system (BIOS) 1014, containing the basic routines that help to transfer information between elements within computer 1002, such as during start-up, is stored in ROM 1012. RAM 1010 typically contains data and/or program modules that are immediately accessible to and/or presently operated on by the processing unit 1004.

Computer 1002 may also include other removable/non-removable, volatile/non-volatile computer storage media. By way of example, FIG. 10 illustrates a hard disk drive 1016 for reading from and writing to a non-removable, non-volatile magnetic media (not shown), a magnetic disk drive 1018 for reading from and writing to a removable, non-volatile magnetic disk 1020 (e.g., a “floppy disk”), and an optical disk drive 1022 for reading from and/or writing to a removable, non-volatile optical disk 1024 such as a CD-ROM, DVD-ROM, or other optical media. The hard disk drive 1016, magnetic disk drive 1018, and optical disk drive 1022 are each connected to the system bus 1008 by one or more data media interfaces 1026. Alternately, the hard disk drive 1016, magnetic disk drive 1018, and optical disk drive 1022 can be connected to the system bus 1008 by one or more interfaces (not shown).

The disk drives and their associated computer-readable media provide non-volatile storage of computer readable instructions, data structures, program modules, and other data for computer 1002. Although the example illustrates a hard disk 1016, a removable magnetic disk 1020, and a removable optical disk 1024, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 1016, magnetic disk 1020, optical disk 1024, ROM 1012, and/or RAM 1010, including by way of example, an operating system 1027, one or more application programs 1028, other program modules 1030, and program data 1032. Each of such operating system 1027, one or more application programs 1028, other program modules 1030, and program data 1032 (or some combination thereof) may implement all or part of the resident components that support the distributed file system.

A user can enter commands and information into computer 1002 via input devices such as a keyboard 1034 and a pointing device 1036 (e.g., a “mouse”). Other input devices 1038 (not shown specifically) may include a microphone, joystick, game pad, satellite dish, serial port, scanner, and/or the like. These and other input devices are connected to the processing unit 1504 via input/output interfaces 1040 that are coupled to the system bus 1008, but may be connected by other interface and bus structures, such as a parallel port, game port, or a universal serial bus (USB).

A monitor 1042 or other type of display device can also be connected to the system bus 1008 via an interface, such as a video adapter 1044. In addition to the monitor 1042, other output peripheral devices can include components such as speakers (not shown) and a printer 1046 which can be connected to computer 1002 via the input/output interfaces 1040.

Computer 1002 can operate in a networked environment using logical connections to one or more remote computers, such as a remote computing-based device 1048. By way of example, the remote computing-based device 1048 can be a personal computer, portable computer, a server, a router, a network computer, a peer device or other common network node, and the like. The remote computing-based device 1048 is illustrated as a portable computer that can include many or all of the elements and features described herein relative to computer 1002.

Logical connections between computer 1002 and the remote computer 1048 are depicted as a local area network (LAN) 1050 and a general wide area network (WAN) 1052. Such networking environments are commonplace in offices, enterprise-wide computer networks, intranets, and the Internet.

When implemented in a LAN networking environment, the computer 1002 is connected to a local network 1050 via a network interface or adapter 1054. When implemented in a WAN networking environment, the computer 1002 typically includes a modem 1056 or other means for establishing communications over the wide network 1052. The modem 1056, which can be internal or external to computer 1002, can be connected to the system bus 1008 via the input/output interfaces 1040 or other appropriate mechanisms. It is to be appreciated that the illustrated network connections are exemplary and that other means of establishing communication link(s) between the computers 1002 and 1048 can be employed.

In a networked environment, such as that illustrated with computing environment 1000, program modules depicted relative to the computer 1002, or portions thereof may be stored in a remote memory storage device. By way of example, remote application programs 1058 reside on a memory device of remote computer 1048. For purposes of illustration, application programs and other executable program components such as the operating system are illustrated herein as discrete blocks, although it is recognized that such programs and components reside at various times in different storage components of the computing-based device 1002, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

The above-described methods and system describe managing networks using dependency analysis. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
computing dependency relationships of network elements related to one another; and
creating a dependency graph based on the dependency relationships.

2. The method of claim 1, wherein the network elements gather the dependency relationships.

3. The method of claim 1, wherein the computing dependency is performed by code implementing dependency agents provided to the network elements.

4. The method of claim 1, wherein the creating comprises creating a network topology view of a network, the network comprising multiple network elements.

5. The method of claim 1, wherein the creating and determining are included as part of managing a network, wherein the managing comprises creating multiple dependency graphs and multiple network topology views.

6. The method of claim 1, wherein the dependency graphs are used in determining probabilities of problems associated with the network elements.

7. The method of claim 6, wherein the determining is performed by a diagnosis algorithm incorporating a Bayesian inference.

8. A network element comprising:
a processor;
a memory accessed by the processor;
a dependency agent configured as part of the memory or separate from the memory, and controlled by the processor, wherein the dependency agent is configured to collect dependency data from a network, the network comprising multiple network elements.

9. The network element of claim 8, wherein the dependency agent comprises a network monitor to collect the dependency data, the network monitor comprising packet sniffing component to inspect packets transmitted and received at the network element and identify potential causalities between packet or co-occurrences between packets.

10. The network element of claim 8, wherein the dependency agent comprises an application monitor to collect dependency data for applications provided by other network elements in the network.

11. The network element of claim 8, wherein the dependency agent comprises a dependency graph analyzer that computes dependencies of the network elements in the network and reports deltas back to the network elements.

12. The network element of claim 8, wherein the dependency agent comprises an agent service that receives requests for collected dependency data and commands to probe the network.

13. The network element of claim 8, wherein the dependency agent comprises a health summarizer that reports the condition and health probability or sickness probability of the network elements in the network.

14. The network element of claim 8, wherein the dependency agent provides the dependency data to a centralized computing device comprising an inference engine.

15. An inference engine comprising:
an aggregation and coordination point to receive dependency data from one or more network elements in a network;
an assembler to create a dependency graph from the dependency data; and
an ordering agent to actively request current dependency data from one or more network elements as to update the dependency graph.

16. The inference engine of claim 15, wherein the inference engine is part of a network element.

17. The inference engine of claim 15, wherein the inference engine is distributed over multiple network elements.

18. The inference engine of claim 15, wherein the dependency data is received from one or more dependency agents in the network.

19. The inference engine of claim 15, wherein the assembler in creating the dependency graph, is configured to batch experience reports to determine performance of the network.

20. The inference engine of claim 15 further comprising an interface to a user allowing the user to manage the network.
